(19) United States
(12) Patent Application Publication
(10) Pub. No.: US 2009/0294304 A1
(43) Pub. Date: Dec. 3, 2009

(54) Electrochemical sensor

(76) Inventors: Mark Hyland, Yarnton (GB); Yann Astier, Yarnton (GB)

Correspondence Address: QUARLES & BRADY LLP, 411 E. WISCONSIN AVENUE, SUITE 2040, MILWAUKEE, WI, 53202-4497, US

(21) Appl. No.: 11/630,657

(22) PCT Filed: Jun. 29, 2005
(86) PCT No.: PCT/GB05/02544

§ 371 Date: Jun. 2, 2009

(30) Foreign Application Priority Data
Jun. 29, 2004 (GB) 0414551.2

(51) Int. Cl. G01N 27/30; G01N 27/26

(52) U.S. Cl. 205/792; 204/403.01

(57) ABSTRACT

A composition suitable for use in an electrochemical detection of ischeamia via albumin cobalt finding test (ACB), said composition comprising (i) a transition metal salt eg. Cobalt; (ii) an electrode area normalising agent having a current which is dependent on electrode area eg. RU (NH₃)6; and (iii) a wetting agent eg. PVP. Also provided is a device comprising—an electrochemical cell having a working electrode (5) and a pseudo reference electrode (6); a composition according to the invention (7); —means for applying a voltage across the cell; and —means for measuring the resulting current across the cell. The device can be used in the electrochemical diagnosis of ischemia.

### FIELD OF THE INVENTION

The present invention relates to a composition for use in an electrochemical sensing method, a method of diagnosing ischemia, and a device suitable for use in such a method.

### BACKGROUND TO THE INVENTION

Ischemia is a condition involving an insufficient supply of blood to an organ, usually due to a blocked artery. In particular, myocardial ischemia is an intermediate condition in coronary artery disease during which the heart tissue is slowly or suddenly starved of oxygen and other nutrients. Myocardial ischemia can be characterised by angina pectoris and, when blood flow to the heart is completely blocked, ischemia can lead to a heart attack. There is a considerable clinical interest in identifying markers of all types of ischemia. In particular, accurate methods for the detection of myocardial ischemia are desired in order that early and accurate diagnosis of cardiac diseases can be made.

One proposed test for the presence of ischemia is the albumin cobalt binding test. This test relies on the observation that albumin in patients with ischemia produces a lower metal binding capacity for cobalt than albumin in non-ischemic normal controls. Cobalt is thought to bind to the N-terminus of albumin in normal, healthy patients. However, it has been proposed that during an ischemic event, alterations occur to the albumin molecule, affecting in particular the N-terminus. Such ischemia modified albumin molecules do not bind to cobalt as would be expected of a healthy albumin molecule. The albumin cobalt binding test therefore detects the presence of ischemia by quantitatively monitoring the degree of cobalt binding to albumin. Typically, a known quantity of cobalt is contacted with the albumin sample and the residual free cobalt present is detected, by optical testing after binding to a dye.

However, the tests proposed in the art require relatively lengthy laboratory analysis in order to determine the residual cobalt content. A significant time delay in determining the results of the tests is therefore a necessity. There is thus a need for an improved test which is convenient to use and provides a more immediate result.

### SUMMARY OF THE INVENTION

The present inventors have developed a new electrochemical testing method for detecting the presence of ischemia. The new technique involves contacting the sample to be tested with a specific composition containing a transition metal salt, for example a cobalt (II) salt. An electrochemical measurement is then carried out to determine the amount of electrochemically detectable transition metal salt that is present in the mixture. It has been found that the amount of electrochemically detectable transition metal salt is higher for an ischemic sample than a healthy sample, based on a constant starting concentration of transition metal salt. Thus, a simple electrochemical test provides an indication of whether a sample is ischemic or healthy.

This electrochemical detection technique is very simple and easy to use. In one embodiment of the invention, the electrochemical test can be carried out on a portable hand-held device and is therefore particularly easy to use in a medical environment. Furthermore, the technique of the present invention provides results in a short period of time, in some cases in under five minutes.

The present invention therefore provides a composition suitable for use in an electrochemical sensing method, said composition comprising
a) a transition metal salt;
b) an electrode area normalising agent having a current which is dependent on electrode area; and
c) a wetting agent.

This composition is useful as a reagent in electrochemical sensing methods, in particular in electrochemical tests to distinguish between healthy and ischemic samples. One proposed theory behind the present invention is that the transition metal salt binds to healthy proteins (e.g. albumin), but is not able to bind, or binds less strongly, to proteins (e.g. albumin) in an ischemic sample. This may be due to an alteration in the structure of the protein molecule following an ischemic event. For example, the albumin molecule is thought to be altered at its N-terminus following an ischemic event.

Transition metal salts which are bound to proteins are typically unavailable for electrochemical detection. Since a lesser degree of binding will occur in an ischemic than a healthy sample, the amount of electrochemically detectable transition metal salt will be greater in the ischemic sample. A higher current will therefore be detected in the ischemic sample. However, whilst it is thought that the present invention works according to this theory, the invention is in no way limited to this theory.

As well as the transition metal salt, the composition contains an agent for normalising for variations in electrode area. The presence of this agent in the reagent composition means that it is not necessary to carry out a separate determination of the real electrode area of a working electrode used in the electrochemical test. A single voltammetric scan can be used to determine both the measured current due to oxidation/reduction of the transition metal, as well as oxidation/reduction of the electrode area normalising agent. Thus, a swift analysis leads to a result in which errors due to variation in electrode area are minimised.

In a typical electrochemical method, the composition will be provided to an electrochemical cell in dried form. A sample will then be added in which the composition re-suspends prior to measurement. The presence of a wetting agent in the composition helps to ensure that re-suspension occurs rapidly, and thus a smaller time delay is required prior to carrying out the electrochemical measurement.

Also provided by the present invention is an electrochemical sensing method comprising
(i) providing an electrochemical cell having a working electrode and a pseudo reference electrode;
(ii) contacting (1) a composition of the invention, and (2) a sample, with each other and with said working electrode;
(iii) applying a potential across the electrochemical cell; and
(iv) electrochemically detecting the presence of free transition metal salt by measuring the resulting current across the cell.

The present invention also provides a device comprising
an electrochemical cell having a working electrode and a pseudo reference electrode;
a material comprising a transition metal salt, which is typically a composition of the invention as defined herein;
means for applying a voltage across the cell; and
means for measuring the resulting current across the cell.

The device of the invention is very straightforward to use. A user simply needs to add the sample to be tested and apply a potential across the cell. There is therefore no need to separately handle the material containing the transition metal salt. Furthermore, the device can contain a predetermined amount of transition metal salt, avoiding the need for the user to measure out particular quantities of material.

The present invention also provides a method of operating the device of the invention, the method comprising
contacting (1) a material comprising a transition metal salt, which is typically a composition of the invention as defined herein, and (2) a sample, with each other and with the working electrode;
applying a potential across the electrochemical cell; and
electrochemically detecting the presence of free transition metal salt by measuring the resulting current across the cell.

The present invention also provides a method, for example an in vitro method, of determining whether a sample of bodily fluid is ischemic, the method comprising
(i) providing an electrochemical cell having a working electrode and a pseudo reference electrode;
(ii) contacting (1) a material comprising a transition metal salt, which is typically a composition of the invention as defined herein, and (2) the sample of bodily fluid with each other and with said working electrode;
(iii) applying a potential across the electrochemical cell; and
(iv) electrochemically detecting the presence of free transition metal salt by measuring the resulting current across the cell.

An ischemic sample is a sample which has been taken from a patient who has suffered an ischemic event. The method can therefore be used as a method of diagnosing ischemia in a patient, the sample of bodily fluid being one taken from the patient. A positive diagnosis of ischemia will result if the measured current is higher than would be expected for a healthy sample, based on the use of the same concentration of transition metal salt in the material (1). In one embodiment, the method is a method of diagnosing myocardial ischemia.

The material comprising a transition metal salt of the device and methods described above typically comprises one or more components selected from
(b) an electrode area normalising agent having a current which is dependent on electrode area; and
(c) a wetting agent.

Preferably, the material comprising a transition metal salt is a composition of the invention as described herein.

### BRIEF DESCRIPTION OF THE FIGURES

FIG. 1 depicts a device according to one embodiment of the invention;

FIG. 2 depicts an alternative device according to the invention;

FIG. 3 depicts a plot of current (I) versus potential (V) for an electrochemical test to determine the quantity of electrochemically detectable cobalt in a sample, the test being carried out using the method of the invention; and

FIG. 4 is a plot of the ratio I(Co)/I(Ru) for a series of healthy samples (1 on the x-axis) and a series of ischemic samples (2 on the x-axis).

### DETAILED DESCRIPTION OF THE INVENTION

The composition of the present invention is a mixture of reagents which, when combined with a sample, will allow the electrochemical differentiation between healthy samples and ischemic samples. The composition is therefore suitable for use in the methods and devices of the invention, and thus in the diagnosis of ischemia.

The composition of the invention is typically employed in a device comprising, in addition to the composition of the invention, an electrochemical cell, means for applying a voltage across the cell and means for measuring a current produced. The sample is typically placed into or onto the device in such a manner that the composition contacts the sample, and both the sample and the composition are in electrical contact with the working electrode of the electrochemical cell. The sample and composition are typically also in electrical contact with the pseudo reference electrode. A voltage is then applied across the cell which causes electrochemical reaction of any free transition metal salt present in the sample/composition mixture. The current caused by this reaction is measured. In a healthy sample, a lower proportion of the transition metal salt is electrochemically detectable than in an ischemic sample. Therefore, an ischemic sample will provide a higher reading than a healthy sample. It is therefore possible to differentiate between healthy and ischemic samples based only on the measured current of the electrochemical cell.

As used herein, free transition metal salt, means transition metal salt in which the transition metal can be electrochemically detected.

The composition of the invention may comprise any transition metal salt which is capable of electrochemically distinguishing between ischemic and healthy samples using the method of the invention. A skilled person would be able to determine whether a transition metal salt is suitable by carrying out the method of the invention on (i) a sample known to be healthy and (ii) a sample known to be ischemic. A suitable transition metal salt will provide a higher current reading for sample (ii) than sample (i). Typically, the transition metal will be capable of binding to healthy proteins, for example proteins present in the blood, but will have a lower binding affinity, or will not bind, to these proteins following an ischemic event. For example, the transition metal may be capable of binding to healthy albumin, but will have a lower binding affinity, or will not bind, to albumin which has been modified following an ischemic event. Examples of suitable transition metal salts include manganese, iron, cobalt, copper, and nickel salts. Cobalt (II) salts are preferred.

The salt is typically one which dissociates in water to give the transition metal ion and the anion. Any anion which provides a salt which is soluble in water and dissociates on dissolution can therefore be used. Examples of suitable salts for use in the invention include halides, for example, chlorides. A preferred salt is cobalt (II) chloride.

The preferred amount of transition metal salt present in the composition depends on the nature of the salt and the sample to be tested, as well as the volume of sample the composition is to be contacted with. Typically, where the transition metal is cobalt (II), the cobalt (II) salt is present in an amount such that when mixed with a sample to be tested (e.g. when a dried composition is re-suspended in a sample), the cobalt(II) concentration in the resulting mixture is from 0.1 to 100 mmoldm⁻³. Where the sample to be tested is plasma, the cobalt (II) salt is preferably present in an amount such that when mixed with a sample to be tested, the cobalt(II) concentration in the resulting mixture is from 1 to 20, preferably from 4.25 to 5.25 mmoldm⁻³. The most preferred concentration of cobalt (II) salt in the mixture is from 4.5 to 5.0, for example about 4.75 mmoldm⁻³. These concentrations may be achieved, for example, using a composition comprising more than 5.5 mmoldm⁻³ (for example 30 to 40 mmoldm⁻³) cobalt (II) salt, and subsequently diluting this composition with a known volume of the sample itself (for example using a composition:sample ratio of 1:1 to 1:20, e.g. 1:5 to 1:10). For example, 0.2% of a composition having a concentration of 35.6 mmoldm⁻³ cobalt (II) salt may be dried into or onto the device of the invention, and subsequently re-suspended in 1.5 μl of sample, providing a concentration of approximately 4.75 mmoldm⁻³ in the resulting mixture.

The composition of the invention also comprises an electrode area normalising agent having a current which is dependent on electrode area. Typically, the electrode area normalising agent has a current which is not dependent on whether or not the sample is ischemic. The electrochemical measurement of the current produced by the transition metal salt is dependent on the surface area of the electrode used for the measurement. Therefore, in order to obtain a more precise measurement of the current generated by the transition metal, it is desirable to normalise the measured value using an electrode area normalising agent. It is not essential, although it is preferred, that the electrode area normalising agent fully and precisely normalises the measured current for electrode area. The normalising agent should, however, provide some degree of correction to account for variation in the electrode area. In the context of the present invention, ‘normalise’ therefore means to provide some degree of correction.

Normalising for electrode area can be done by measuring the current produced by the electrochemical reaction of the electrode area normalising agent substantially simultaneously with the measurement of the transition metal current. The same electrode is used for both measurements. The current measured due to oxidation/reduction of the transition metal can then be normalised using the measurement obtained for the electrode area normalising agent, by any suitable technique.

For example, a more accurate result can be obtained using the value I_{TM}/I_{NA} wherein I_{TM} is the current obtained due to oxidation/reduction of the transition metal and I_{NA} is the current obtained due to oxidation/reduction of the electrode area normalising agent. By using this normalised value for the transition metal current, errors in the measured result due to changes in electrode area can be minimised.

The electrode area normalising agent has a reduction/oxidation potential different from the transition metal. Further, it typically does not bind, or binds only weakly, to proteins, for example proteins in the blood including albumin. The electrode area normalising agent typically contains a heavy metal such as ruthenium or osmium. Examples of suitable electrode area normalising agents therefore include ruthenium or osmium complexes, for example complexes with amine-based ligands. Preferred electrode area normalising agents include ruthenium and osmium hexaamine chlorides, in particular ruthenium hexaamine chloride.

Typically, the electrode area normalising agent is present in an amount such that when mixed with a sample to be tested (e.g. when a dried composition is re-suspended in a sample), the electrode area normalising agent concentration in the resulting mixture is from 0.1 to 100 mmoldm⁻³, preferably from 0.1 to 10 mmoldm⁻³, more preferably from 3 to 3.5 or about 3.2 mmoldm⁻³. These concentrations may be achieved, for example, using a composition comprising greater than 5 mmoldm⁻³ (for example 20 to 30 mmoldm⁻³) and subsequently diluting the composition with a known volume of the sample itself (for example using a composition:sample ratio of 1:1 to 1:20, e.g. 1.5 to 1:10). For example, 0.2 μl of a composition having a concentration of 24 mmoldm⁻³ electrode area normalising agent may be dried into or onto the device of the invention, and subsequently re-suspended in 1.5 μL of sample, providing a concentration of approximately 3.2 mmoldm⁻³ in the resulting mixture.

In one embodiment, the device of the present invention comprises a silver/silver chloride counter and/or pseudo reference electrode. In order to provide a stable measurement, sufficient chloride must be present in the electrochemical cell. The composition of the invention may therefore comprise a chloride salt to assist in providing the required level of chloride. Preferred chloride salts are alkali metal chlorides, alkaline earth metal chlorides and ammonium chloride. Potassium and sodium chloride are particularly preferred. The chloride salt is typically present in an amount such that when mixed with a sample to be tested (e.g. when a dried composition is re-suspended in a sample), the chloride salt concentration in the resulting mixture is from 1 to 300 mmoldm⁻³, preferably from 6 to 60 mmoldm⁻³, more preferably from 10 to 30 mmoldm⁻³. The chloride salt may, however, be present at a lower concentration or be absent entirely, in particular where the sample itself contains chloride salts.

In alternative embodiments of the invention, the counter and/or pseudo reference electrode is made of a different metal/salt combination. In this case, the anion which is typically added to the composition corresponds to that used in the counter/reference electrode. For example, where a Ag/Ag₂SO₄ counter/reference electrode is used, a sulfate salt is typically added to the composition. Suitable sulfate salts include alkali metal and alkaline earth-metal sulfates and ammonium sulfate, in particular potassium and sodium sulfate.

In a typical device of the invention, the composition is inserted into the device in liquid form and then dried in position. In order to take an electrochemical measurement, a liquid sample is contacted with the composition and the composition re-suspends in the liquid sample. In order to aid this re-suspension step, the composition of the invention comprises a wetting agent. The wetting agent can increase the speed at which the dried composition re-suspends.

A preferred wetting agent is polyvinylpyrolidone (PVP). PVP is typically present in an amount such that when the composition is mixed with a sample to be tested, the PVP concentration in the resulting mixture is from 0.01 to 30% w/v, for example 0.2 to 5% w/v, preferably 0.7% w/v. The composition itself may have a higher concentration of PVP which is then diluted with a known volume of sample to provide the required concentration. If the concentration of polyvinylpyrolidone is too high, re-suspension occurs slowly. Thus, typically no more than 5% w/v, preferably no more than 20% w/v or 1.50% w/v, more preferably no more than 1% w/v polyvinylpyrolidone is present. However, if the concentration of polyvinylpyrolidone is too low, insufficient wetting properties are provided.

The polyvinylpyrolidone typically has an average molecular weight of up to 100,000. Preferred average molecular weights are at least 5000, more preferably at least 7,500. Further, the molecular weight is preferably no more than 50,000, more preferably no more than 20,000, for example no more than 15,000 or no more than 12,500. A preferred average molecular weight is about 10,000. Use of polyvinylpyrolidone having such a molecular weight has been found to lead to faster re-suspension of the composition.

Electrochemical measurements are preferably taken at a pH of from 6 to 8, for example from 6.5 to 7.5, preferably from 6.8 to 7.2. A buffer can be included in the composition of the invention to ensure that the pH of the composition once re-suspended in a sample to be tested remains substantially within the range 6 to 8. The buffer should be one that provides a pH of from 6 to 8 when the composition is suspended or dissolved in water. Any buffer can be used which is not electrochemically active over the potential range of the measurement to be carried out. Suitable buffers will be known to those skilled in the art and an example of a buffer which can be used is (N-morpholino)propanesulphonic acid (MOPS).

Preferred compositions of the invention comprise a manganese, iron, cobalt, nickel or copper salt; a ruthenium or osmium complex; a wetting agent; optionally a chloride or sulphate salt; and optionally a buffer. Particularly preferred compositions comprise a cobalt salt, a ruthenium or osmium complex; polyvinylpyrrolidone; optionally a chloride or sulphate salt; and optionally a buffer. In a preferred embodiment a buffer is included in these compositions.

The composition of the invention can be present as a suspension, for example a suspension in water. Alternatively, the composition may be provided in dried form, or as gel.

In a method according to the present invention, a material comprising a transition metal salt is contacted with a sample, and both said material and said sample are contacted with a working electrode of an electrochemical cell. Contact also typically occurs between the pseudo reference (and optional separate counter) electrode(s) and the sample. The sample which contacts these later electrodes is optionally mixed with the material comprising a transition metal salt. Typically, the material comprising the transition metal salt is provided to the electrochemical cell prior to addition of the sample. If the material is in dried form, the sample is preferably in liquid form so that the material forms a suspension in the liquid sample.

The material comprising a transition metal salt may consist of said transition metal salt, or it may comprise additional ingredients. Preferred materials comprising a transition metal salt additionally comprise one or more components selected from an electrode area normalising agent, a wetting agent and preferably also a buffer. The nature and amounts of transition metal salt, electrode area normalising agent, wetting agent and buffer are preferably as defined above with reference to the composition of the invention. Preferred materials comprising a transition metal salt are the compositions of the invention as defined above.

Measurements in accordance with the present invention can be carried out on any suitable sample. Preferred samples are in liquid form. Measurements are typically carried out on bodily fluids, for example whole blood or blood components, for example serum or plasma. Where the measurement is carried out on whole blood, the measurement obtained will depend on the hematocrit. The measurement should therefore ideally be adjusted to at least partially account for this factor. Preferred samples for use in the method of the present invention are serum and plasma, in particular plasma.

For the purposes of the present invention, the sample is the material which contacts the working electrode. In one embodiment, a specimen comprising the sample is supplied to the device of the invention. A filter, for example a filtration membrane, is positioned in the device such that the specimen is filtered prior to contacting the working electrode. For example, the specimen may be whole blood and a blood filtration membrane may be present which, for example, allows only plasma to pass through. In this case, the sample is plasma.

In a preferred embodiment, the method is carried out by contacting a predetermined amount of the transition metal salt with the sample. The amount of the sample is also preferably fixed, such that the concentration of the transition metal salt, once taken up in the sample, is known. In this embodiment, measurement of the current produced by oxidation/reduction of the transition metal salt directly leads to an indication of the amount of free transition metal salt available. A technique for providing more accurate measurement in this embodiment is described in GB application no. 0414550.4 and the international application claiming priority therefrom (filed on the same day as the present application and entitled ELECTROCHEMICAL SENSING METHOD), the contents of which are incorporated herein by reference in their entirety.

The device of the present invention comprises an electrochemical cell having a working electrode and a pseudo reference electrode, a material comprising a transition metal salt, means for applying a voltage across the cell and means for measuring any resulting current. The material comprising a transition metal salt may be present in either liquid or solid form, but is preferably in solid form. Typically, the material comprising a transition metal salt is inserted into or placed onto the device whilst suspended/dissolved in a suitable liquid (e.g. water) and then dried in position. This step of drying the material into/onto the device helps to keep the material in the desired position. Drying may be carried out, for example, by air-drying, vacuum drying, freeze drying or oven drying (heating).

In one embodiment of the invention, the electrochemical cell is in the form of a receptacle. The receptacle may be in any shape as long as it is capable of containing a liquid which is placed into it. For example, the receptacle may be cylindrical. Generally, a receptacle will contain a base and a wall or walls which surround the base. In this embodiment, the material comprising a transition metal salt is typically located in the receptacle.

It is preferred that the electrochemical cell has at least one microelectrode. Typically, the working electrode is a microelectrode. For the purposes of this invention, a microelectrode is an electrode having at least one dimension not exceeding 50 μm. The microelectrodes of the invention may have a dimension which is macro in size, i.e. which is greater than 50 μm.

An electrochemical cell may be either a two-electrode or a three-electrode system. A two-electrode system comprises a working electrode and a pseudo reference electrode. A three-electrode system comprises a working electrode, a pseudo reference electrode and a separate counter electrode. As used herein, a pseudo reference electrode is an electrode that is capable of providing a reference potential. In a two-electrode system, the pseudo reference electrode also acts as the counter electrode and is thus able to pass a current without substantially perturbing the reference potential.

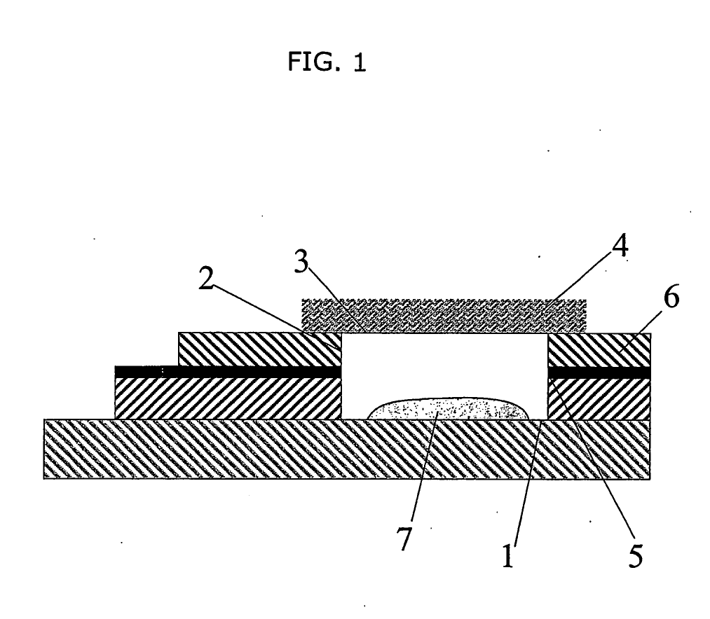

A device according to one embodiment of the invention is depicted in FIG. 1. In this embodiment, the working electrode 5 is a microelectrode. The cell is in the form of a receptacle or a container having a base 1 and a wall or walls 2. Typically, the receptacle will have a depth (i.e. from top to base) of from 25 to 1000 μm. In one embodiment, the depth of the receptacle is from 50 to 500 μm, for example from 100 to 250 μm. In an alternative embodiment, the depth of the receptacle is from 50 to 1000 μm, preferably from 200 to 800 μm, for example from 300 to 600 μm. The length and width (i.e. from wall to wall), or in the case of a cylindrical receptacle the diameter, of the receptacle is typically from 0.1 to 5 mm, for example from 0.5 to 2.0 mm, e.g. 0.5 to 1.5 mm, such as 1 mm.

The open end of the receptacle 3 may be partially covered by an impermeable material as long as at least part of the open end is uncovered, or covered by a semi-permeable or permeable material, such as a semi-permeable or permeable membrane. Preferably, the open end of the receptacle is substantially covered with a semi-permeable or permeable membrane 4. The membrane 4 serves, inter alia, to prevent dust or other contaminants from entering the receptacle.

The membrane 4 is preferably made of a material through which the sample to be tested can pass. For example, if the sample is plasma, the membrane should be permeable to plasma. The membrane also preferably has a low protein binding capacity. Suitable materials for use as the membrane include polyester, cellulose nitrate, polycarbonate, polysulfone, microporous polyethersulfone films, PET, cotton and nylon woven fabrics, coated glass fibres and polyacrylonitrile fabrics. These fabrics may optionally undergo a hydrophilic or hydrophobic treatment prior to use. Other surface characteristics of the membrane may also be altered if desired. For example, treatments to modify the membrane's contact angle in water may be used in order to facilitate flow of the desired sample through the membrane. The membrane may comprise one, two or more layers of material, each of which may be the same or different. For example, conventional double layer membranes comprising two layers of different membrane materials may be used.

The membrane may also be used to filter out some components which are not desired to enter the cell. For example, some blood products such as red blood cells or erythrocytes may be separated out in this manner such that these particles do not enter the cell. Suitable filtration membranes, including blood filtration membranes, are known in the art. Examples of blood filtration membranes are Presence 200 of Pall filtration, Whatman VF2, Whatman Cyclopore, Spectral NX and Spectral X. Fibreglass filters, for example Whatman VF2, can separate plasma from whole blood and are suitable for use where a whole blood specimen is supplied to the device and the sample to be tested is plasma.

The electrochemical cell of this embodiment of the invention contains a working electrode 5 which is situated in a wall of the receptacle. The working electrode is, for example, in the form of a continuous band around the wall(s) of the receptacle. The thickness of the working electrode is typically from 0.01 to 25 μm, preferably from 0.05 to 15 μm, for example 0.1 to 20 μm, more preferably from 0.1 to 10 μm. Thicker working electrodes are also envisaged, for example electrodes having a thickness of from 0.1 to 50 μm, preferably from 5 to 20 μm. The thickness of the working electrode is its dimension in a vertical direction when the receptacle is placed on its base. The working electrode is preferably formed from carbon, palladium, gold, platinum, silver or copper, e.g. carbon, palladium, gold or platinum, for example in the form of a conductive ink. The conductive ink may be a modified ink containing additional materials, for example platinum and/or graphite. Two or more layers may be used to form the working electrode, the layers being formed of the same or different materials.

The cell also contains a pseudo reference electrode which may be present, for example, in the base of the receptacle, in a wall or walls of the receptacle or in an area of the device surrounding or close to the receptacle. The pseudo reference electrode is typically made from Ag/AgCl, although other materials may also be used. Suitable materials for use as the pseudo reference electrode will be known to the skilled person in the art. In this embodiment, the cell is a two-electrode system in which the pseudo reference electrode acts as both counter and reference electrodes. Alternative embodiments in which a separate counter electrode is provided can also be envisaged.

The pseudo reference electrode typically has a surface area which is of a similar size to, or which is larger than, for example substantially larger than, that of the working electrode 5. Typically, the ratio of the surface area of the pseudo reference electrode to that of the working electrode is at least 1:1, for example at least 2:1 or at least 3:1. A preferred ratio is at least 4:1. The pseudo reference electrode may, for example, be a macroelectrode. Preferred pseudo reference electrodes have a dimension of 0.01 mm or greater, for example 0.1 mm or greater. This may be, for example, a diameter of 0.1 mm or greater. Typical areas of the pseudo reference electrode are from 0.001 mm² to 150 mm², e.g. up to 100 mm², preferably from 0.1 mm² to 60 mm², for example from 1 mm² to 50 mm². The minimum distance between the working electrode and the pseudo reference electrode is, for example from 10 to 1000 μm, for example from 10 to 300 μm or from 400 to 700 μm.

In order that the cell can operate, the electrodes must each be separated by an insulating material 6. The insulating material is typically a polymer, for example, an acrylate, polyurethane, PET, polyolefin, polyester or any other stable insulating material. Polycarbonate and other plastics and ceramics are also suitable insulating materials. The insulating layer may be formed by solvent evaporation from a polymer solution. Liquids which harden after application may also be used, for example varnishes. Alternatively, cross-linkable polymer solutions may be used which are, for example, cross-linked by exposure to heat or UV or by mixing together the active parts of a two-component cross-linkable system. Dielectric inks may also be used to form insulating layers where appropriate. In an alternative embodiment, an insulating layer is laminated, for example thermally laminated, to the device.

The electrodes of the electrochemical cell may be connected to any required measuring instruments by any suitable means. Typically, the electrodes will be connected to electrically conducting tracks which are, or can be, themselves connected to the required measuring instruments.

The material comprising a transition metal salt is typically contained within the receptacle, as depicted at 7 in FIG. 1. Typically, the material comprising a transition metal salt is inserted into the receptacle in liquid form and subsequently dried to help immobilise the composition. On introduction of the sample into the receptacle, the dried material is re-suspended forming a liquid comprising the transition metal salt and the sample, the liquid being in contact with the working electrode which is located in the wall of the receptacle. The liquid is also typically in contact with the pseudo reference electrode. Thus, on application of a voltage across the cell, electrochemical reaction may occur and a measurable current be produced. Typically, a wet-up time, for example of one second, or from 1 to 60 seconds where a membrane is present over the receptacle, is provided before a voltage is applied, to allow the dried material to re-suspend.

The receptacle may, for example, contain one or more small air-holes in its base or its wall or walls (not depicted in FIG. 1). These holes allow air to escape from the receptacle when sample enters the receptacle. If such air-holes are not present, the sample may not enter the receptacle when it flows over the open end, or it may enter the receptacle only with difficulty. The air holes typically have capillary dimensions, for example, they may have an approximate diameter of 1-600 μm, for example from 100 to 500 μm. The air holes should be sufficiently small that the sample is substantially prevented from leaving the receptacle through the air holes due to surface tension. Typically, 1 or more, e.g. from 1 to 4 air holes may be present.

The cell may optionally comprise a separate counter electrode in addition to the working and pseudo reference electrodes. Suitable materials for producing the counter electrode will be known to the skilled person in the art. Ag/AgCl is an example of a suitable material.

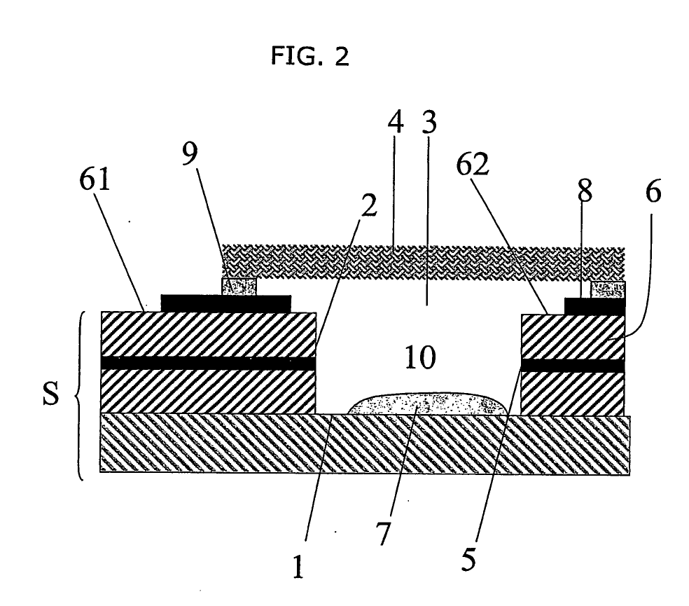

An alternative device according to the invention is depicted in FIG. 2. The device of this embodiment is the same as the device depicted in FIG. 1 and described above, except as set out below. In this embodiment, the device comprises a strip S. The strip S may have any shape and size, but typically has a first surface 61, 62 which is substantially flat. The strip comprises a receptacle 10 bounded by base 1 and wall or walls 2. The device further comprises an electrochemical cell having a working electrode 5 in the wall(s) of the receptacle. The working electrode is typically a microelectrode.

The device of this embodiment comprises a pseudo reference electrode acting as reference electrode and optionally also as counter electrode. The pseudo reference electrode comprises a pseudo reference electrode layer 8 present on the first surface of the strip 61, 62. The first surface of the strip is an external surface, i.e. it is a surface exposed to the outside of the device rather than a surface exposed to the interior of the receptacle. Typically, the pseudo reference electrode layer substantially surrounds the receptacle or partial receptacle 10. As depicted in FIG. 2, it is preferred that the pseudo reference electrode layer is not in contact with the perimeter of the first open part 3. Typically, the pseudo reference electrode layer is at a distance of at least 0.1 mm, preferably at least 0.2 mm from the perimeter of the first open part. At least a part of the pseudo reference electrode is, however, typically no more than 2 mm, for example no more than 1 mm or 0.5 mm, preferably no more than 0.4 mm from the perimeter of the first open part. In one embodiment, the pseudo reference electrode substantially surrounds the receptacle or partial receptacle at a distance of from 0.01 to 1.0 mm, for example from 0.1 to 0.5 mm, or 0.2 to 0.4 mm from the perimeter of the first open part. Alternatively, this distance may be from 0.01 to 0.3 mm or from 0.4 to 0.7 mm.

The thickness of the pseudo reference electrode is typically similar to or greater than the thickness of the working electrode. Suitable minimum thicknesses are 0.1 μm, for example 0.5, 1, 5 or 10 μm. Suitable maximum thicknesses are 50 μm, for example 20 or 15 μm.

The pseudo reference electrode 8 typically has a surface area which is of a similar size to, or which is larger than, for example substantially larger than, that of the working electrode 5. Typically, the ratio of the surface area of the pseudo reference electrode to that of the working electrode is at least 1:1, for example at least 2:1 or at least 3:1 preferably at least 4:1. The pseudo reference electrode may, for example, be a macroelectrode. Where the ratio of the surface area of the pseudo reference electrode to that of the working electrode is greater than 1:1, this helps to ensure that the electrochemical reaction occurring at the pseudo reference electrode is not current-limiting. The actual area of the pseudo reference electrode is, for example, from 0.001 mm² to 150 mm², e.g. up to 100 mm² or from 0.1 mm² to 60 mm², for example from 1 mm² to 50 mm².

A membrane 4 may be attached to the device by any suitable attachment means 9, for example using a double-sided adhesive tape. Typically, the attachment means attaches the membrane to the first surface of the strip or to the pseudo reference electrode layer. In a preferred embodiment as depicted in FIG. 2, the membrane is attached to the pseudo reference electrode layer 8 at a location which is remote from the perimeter of the receptacle itself. Further, the attachment means is at a greater distance from the first open part of the receptacle 3 than the pseudo reference electrode layer, such that at least a part of the surface of the pseudo reference electrode layer close to or surrounding the receptacle is exposed to a sample which has passed through the membrane. Preferably, the attachment means is at least 0.2 mm, for example at least 0.3 mm or at least 0.4 mm, from the perimeter of the receptacle.

In the embodiment depicted in FIG. 2, a reaction volume is defined by the receptacle base 1 and walls 2, part of the surface of the strip 61, 62, the pseudo reference electrode layer 8, the attachment means 9 and the membrane 4. This reaction volume can be varied by changing the volume of the receptacle, the position and thickness of the pseudo reference electrode layer and the position and thickness of the attachment means 9. Preferred reaction volumes are at least 0.05 μl, for example at least 0.1 or at least 0.2 μl. It is further preferred that the reaction volume is no more than 25 μl, preferably no more than 5 μl, for example no more than 3 μl or no more than 2 μl.

Further details regarding electrochemical cells which can be used in the devices of the present invention can be found in WO 03/05319 and GB 0414546.2 and the international application claiming priority therefrom (entitled ELECTRODE FOR ELECTROCHEMICAL SENSOR and filed on the same day as the present application). The contents of these applications are incorporated herein by reference in their entirety.

The devices of the invention may comprise two or more electrochemical cells. Each cell comprises a working electrode and may additionally comprise a counter electrode. Alternatively, two or more adjacent cells may employ the same counter electrode. This embodiment of the invention allows a number of measurements to be taken simultaneously, for example to assist in the elimination of errors in the measurements taken.

The devices of the invention can be produced by forming a laminate structure comprising a layer of working electrode material (e.g. a layer of graphite) between two layers of insulating material. A hole is then punched (or drilled or cut) through this laminate, thus forming the wall(s) of the receptacle. A base, optionally comprising a counter electrode, is then added. The counter electrode may alternatively be provided by printing a layer of a suitable material onto the insulating material surrounding, or close to, the open part of the receptacle. Where an air hole is desired in the base or wall(s) of the receptacle, this can be formed by any suitable technique, for example by drilling or punching a hole. Full details regarding the process for producing cells as depicted in FIG. 1 can be obtained from WO 03/056319 or GB 0414546.2 and the international application claiming priority therefrom (entitled ELECTRODE FOR ELECTROCHEMICAL SENSOR), each of which are referenced above.

The device of the present invention is operated by providing a sample to the device, applying a voltage across the cell and measuring the current produced by electrochemical reaction of the transition metal. The sample/transition metal salt mixture should be in electronic contact with the working electrode in order that electrochemical reaction can occur at the electrode.

Typically, when cobalt (II) is the transition metal, the voltage applied across the cell is scanned, for example from 0V to about −0.5V then to about 1.9V. (All voltages mentioned herein are quoted against a Ag/AgCl reference electrode). A maximum voltage of at least 1.7V should be reached in order that the cobalt (II) peak is detected. Suitable scan rates are, for example, in the region of 50 mVs⁻¹. Where a different transition metal is used, the maximum potential can be varied in order that the transition metal peak falls within the range of voltages scanned. The scanned voltage should also encompass the potential range in which oxidation/reduction of the electrode area normalizing agent is seen. In the case of a ruthenium complex, this is typically around −0.4V. Alternatively, a static potential may be applied, if desired.

In one embodiment, prior to applying the voltage, the electrode is pre-conditioned, for example in accordance with the technique described in GB 0414548.8 and the international application claiming priority therefrom (filed on the same day as the present application and entitled ELECTRODE PRECONDITIONING), the contents of which are incorporated herein by reference in their entirety. Measurement of the current may be carried out by any technique known in the art. For example, a number of measurements may be taken over a period of 1 second to 1 minute.

### Example

A device of the type depicted in FIG. 2, wherein the working electrode is a carbon electrode and the pseudo reference electrode is a Ag/AgCl electrode, was used to carry out electrochemical tests. The volume of the receptacle defined by the base, walls, strip surface, adhesive and bottom surface of the membrane was 1.5 ul. A reagent mixture comprising 35.6 mmoldm⁻³ CoCl₂, 24 mmoldm⁻³ Ru Hexaamine Chloride and 150 mmoldm⁻³ KCl in MOPS buffer containing 5% w/v PVP (pH of 7.0) was inserted into the receptacle of the device and dried, prior to attachment of a membrane over the device. The membrane used was a Whatman VF2 membrane.

Normal plasma was applied to the electrochemical cell, with 1.5 ul filling the well volume, and the reagent mixture allowed to re-suspend in the plasma. The final resuspended concentration of Co was 4.75 mmoldm⁻³ and the final resuspended concentration of Ru was 3.2 mmoldm⁻³.

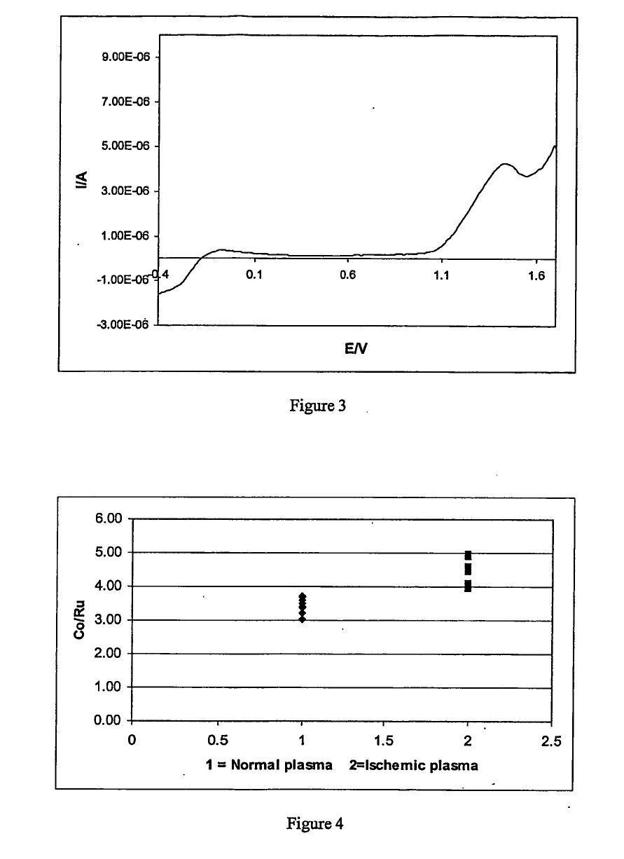

A time varying potential was applied to the cell, the applied potential being decreased to −0.4V and then increased to 1.7V. The current was measured during the potential scan and the results are depicted in FIG. 3. The ratio of I(Co):I(Ru) was also calculated in order to normalise the measured cobalt oxidation current for electrode area.

A number of tests were carried out in the above manner to determine the current ratio I(Co):I(Ru)(Co/Ru) for a number of different plasma samples, including (1) healthy plasma samples and (2) plasma samples from an ischemic patient. The samples were classified as healthy or ischemic according the ACB test from Ischemia Technologies Inc. Denver, U.S.A. (Clinical Chemistry, vol 47, pp 464 to 470 (2001)). The results are depicted in FIG. 4 in which the results for healthy samples are set out at 1 on the x-axis and the results for ischemic samples are set out at 2 on the x-axis. The y-axis shows the Co/Ru current ratio. The results demonstrate that the method of the invention provides the ability to distinguish between healthy samples and those from an ischemic patient. The degree of differentiation between healthy and ischemic samples which is provided by the present invention is equivalent to that provided by the ACB test referred to above.

The invention has been described with reference to various specific embodiments and examples. However, it is to be understood that the invention is in no way limited to these specific embodiments and examples.

1. A composition suitable for use in an electrochemical sensing method, said composition comprising:
(a) a transition metal salt;
(b) an electrode area normalising agent having a current which is dependent on electrode area; and
(c) a wetting agent.

2. A composition according to claim 1, wherein the transition metal salt is a manganese, iron, cobalt, copper or nickel salt.

3. A composition according to claim 2, wherein the transition metal salt is a cobalt salt.

4. A composition according to claim 1, wherein the electrode area normalising agent is a ruthenium or osmium complex.

5. A composition according to claim 1, wherein the wetting agent is polyvinylpyrrolidone.

6. A composition according to claim 5, wherein the polyvinylpyrolidone has an average molecular weight of from 7,500 to 12,500.

7. A composition according to claim 1, which composition additionally comprises a chloride salt or a sulfate salt.

8. A composition according to claim 1, which composition additionally comprises a buffer such that the pH of the composition when suspended or dissolved in water is from pH 6 to 8.

9. A composition according to claim 8, wherein the buffer is (N-morpholino) propanesulfonic acid (MOPS).

10. Use of a composition as defined claim 1 as a reagent in an electrochemical sensing method.

11. An electrochemical sensing method comprising:
(i) providing an electrochemical cell having a working electrode and a pseudo reference electrode;
(ii) contacting (1) a composition as defined in claim 1, and (2) a sample, with each other and with said working electrode;
(iii) applying a potential across the electrochemical cell; and
(iv) electrochemically detecting the presence of free transition metal salt by measuring the resulting current across the cell.

12. A method according to claim 11, which further comprises the step of detecting the current resulting from electrochemical reaction of the electrode area normalising agent and normalising the measurement obtained in step (iv) to account for changes in the electrode area.

13. A method according to claim 11, wherein the sample is whole blood, plasma or serum.

14. A method according to claim 11, wherein the working electrode has at least one dimension of less than 50 μm.

15. A method according to claim 11, wherein the composition is provided to the electrochemical cell prior to addition of the sample.

16. A device comprising
an electrochemical cell having a working electrode and a pseudo reference electrode;
a composition as defined in claim 1;
means for applying a voltage across the cell; and
means for measuring the resulting current across the cell.

17. A device according to claim 16, wherein the working electrode has at least one dimension of less than 50 μm.

18. A device according to claim 16, wherein the composition is in dried form.

19. A device according to claim 16, wherein the electrochemical cell is in the form of a receptacle, said working electrode is in a wall of the receptacle and said composition is at least partly contained within said receptacle.

20. (canceled)

21. A method of operating a device as defined in claim 16, said method comprising
(i) contacting (1) a composition as defined in claim 1, and (2) a sample, with each other and with the working electrode;
(ii) applying a potential across the electrochemical cell; and
(iii) electrochemically detecting the presence of free transition metal salt by measuring the resulting current across the cell.
